(19) United States
(12) Patent Application Publication
(10) Pub. No.: US 2007/0005258 A1
(43) Pub. Date: Jan. 4, 2007

(54) Identification of ligands for macromolecules

(76) Inventors: Frank Guarnieri, Brooklyn, NY (US); Frank P. Hollinger, Wayne, PA (US); Stephan Brunner, Preverenges (CH); William Chiang, Pennington, NJ (US); Matthew Clark, Wayne, PA (US); George Talbot, Philadelphia, PA (US); Jason Ferrara, Yardley, PA (US)

Correspondence Address: STERNE, KESSLER, GOLDSTEIN & FOX PLLC, 1100 NEW YORK AVENUE, N.W., WASHINGTON, DC, 20005, US

(21) Appl. No.: 11/146,417

(22) Filed: Jun. 7, 2005

Related U.S. Application Data
(60) Provisional application No. 60/577,176, filed on Jun. 7, 2004.

(51) Int. Cl. G06F 19/00

(52) U.S. Cl. 702/19

(57) ABSTRACT

Methods and systems of analyzing positions and orientations of molecular fragments to generate macromolecular binding ligands, including analyzing the positions and orientations of molecular fragments in relation to other molecular fragments to bond the molecular fragments to form ligands.

### BACKGROUND OF THE INVENTION

1. Field of the Invention

The invention relates to methods and systems of analyzing the positions and orientations of a plurality of molecular fragments in order to bond selected fragments to generate protein binding ligands. The invention also relates to analyzing and compiling information regarding a large set of molecular fragments.

2. Background Art

Because of recent advances in molecular biology, the three-dimensional molecular structures of many biological target proteins are now known and it has been assumed that knowledge of the structure of the target protein could be used to rationally select the most active hypothetical molecules for actual synthesis for testing their applicability as potential drugs. The key factor of the activity of a drug molecule is the stability of its complex with a particular protein. The stability of the complex is measured by the binding free energy. The prediction of the relative binding energies of different drug candidates with respect to the same protein host is one of the most sought after hopes of the pharmaceutical industry. Chemists often hypothesize dozens of molecules they might synthesize but have trouble deciding which ones have the best chance of being highly active in some biological assay. Computational techniques that help the chemists selecting the most promising candidates for synthesis are extremely valuable. Unfortunately, the thermodynamics of binding is quite complex and using the state-of-the-art arsenal of computational methods requires very time-consuming computer simulations.

For calculations of the relative binding energies of different drugs for a given protein receptor to work properly, many different things have to be done correctly. In particular, the gas phase potential energy force field has to be accurate, the effect of solvent has to be included in some realistic and efficient way, and all the vibrational and conformational states of the system have to be sampled with the correct Boltzmann weights. This last issue is known as the sampling problem and is a particularly difficult one to solve because the drug-receptors complex may exist in many different conformations. Furthermore, these different conformations may be separated by large energy barriers that prevent these conformations from being inter-converted using traditional simulation methods. Recent studies suggest that the length of contemporary free energy simulations of flexible biological molecules may be orders of magnitude too short for convergence and any agreement with experiment may be only fortuitous (i.e. not predictive).

Accordingly, it is difficult to accurately calculate the binding energy between a particular ligand and a macromolecule or protein of interest. However, such information can be crucial in identifying useful drugs from a variety of many possible candidates.

Moreover, to accurately simulate potential ligands, or fragments of potential ligands, a large amount of computation time is necessary. Methods of analyzing and compiling the data, for example, by reducing the amount of data without sacrificing accuracy are necessary.

The present invention addresses the problem of designing appropriate macromolecular ligands by using a fragment-based approach in which fragments are used as building blocks to form ligands. The present invention also addresses the problem of analyzing and compiling the large amount of data that necessarily results from an accurate fragment-based approach without sacrificing the accuracy of the calculation.

### BRIEF SUMMARY OF THE INVENTION

In one aspect, the invention provides methods and systems of analyzing and compiling information regarding a large set of molecular fragments. The information regarding the molecular fragments can include, without limitation, fragment positions and orientations with respect to each other and a macromolecule, to identify and/or design protein binding ligands. In certain embodiments, the invention provides a method of reducing the amount of data output from a computer simulation between a macromolecule and a plurality of fragments, comprising from a set of locations, orientations and free energy values for a plurality of molecular fragments, clumping the molecular fragments that are close to each other in three dimensional space and that have similar orientations; averaging one or more features of the fragments that are clumped; and assigning the one or more averaged features to a representative fragment of said clump, and determining which clumps are in orientations such that they could be chemically bonded together.

### BRIEF DESCRIPTION OF THE FIGURES

FIG. 1a is a single Fragment A in the presence of a protein, which is shown as a surface.

FIG. 1b is a single Fragment B in the presence of a protein, which is shown as a surface.

FIG. 2a is a representative clump of Fragment A in the presence of a protein. The close proximity and orientation of the members of the clump to each other permits this clump to be represented by a single fragment for building purposes.

FIG. 2b is a representative clump of Fragment B in the presence of a protein. The close proximity and orientation of the members of the clump to each other permits this clump to be represented by a single fragment for building purposes.

FIG. 3a is a representation of the distribution of Fragment A in the presence of a protein. The distribution is composed of multiple clumps.

FIG. 3b is a representation of the distribution of Fragment B in the presence of a protein. The distribution is composed of multiple clumps.

FIG. 4 is Fragment A linked to Fragment B by applying specific chemistry build criteria, e.g., bond length and angle tolerances. The members of each fragment's distributions was considered to make the bond connection.

FIG. 5 is Fragment A linked to Fragment B by applying specific chemistry build criteria, e.g., bond length and angle tolerances. This figure shows all possible molecules made by considering members of each fragment's distributions and shows the distribution of the molecule in the presence of the protein.

FIG. 6 illustrates the fragment connection from the fragment distribution to produce a molecule: (6a) is the distribution of Fragment A and Fragment B in the presence of the protein, represented as a surface; 6(b) is the distribution of Fragment A and Fragment B in the absence of the protein; 6(c) is the distribution of Fragment A and Fragment B in the absence of the protein, rotated about 90° forward from the representation in FIG. 6(b). The subspace of combining the fragments appropriately is less than the space occupied by the combined distribution space of Fragment A and Fragment B.

FIG. 7 is a plot of the number of fragments, y axis, versus the predicted binding energy, x axis. Region A is the pre-transition region, Region B is the region just after the transition region, and Region C is the high affinity post transition phase region.

FIG. 8 is an illustration of fragments of naphthalene and a protein corresponding to Region A in FIG. 7.

FIG. 9 is an illustration of fragments of naphthalene and a protein corresponding to Region B in FIG. 7.

FIG. 10 is an illustration of fragments of naphthalene and a protein corresponding to Region C in FIG. 7.

FIG. 11 is a flowchart representing an embodiment of the ligand build process.

FIG. 12 is a flowchart representing an embodiment of the ligand build process wherein two fragments are bonded at more than one atom position.

FIG. 13 is a flowchart representing an embodiment of the ligand build process wherein more than two fragments are bonded.

FIG. 14 is a flowchart representing an embodiment of the ligand build process, wherein fragments are connected to form cyclic structures.

FIG. 15 is a block diagram illustrating a computer platform on which a software embodiment of the invention can be stored and executed.

### DETAILED DESCRIPTION OF THE INVENTION

Definition of Terms

Clump

In embodiments, the present invention performs clumping to compress the raw data from a simulation between a macromolecule, such as a polypeptide or protein, and a group of molecular fragments. Clumping works as follows: if two or more fragments are close enough to each other in three dimensional space, and have similar orientations, they are put into a clump. Fragments within the clump are averaged, creating a representative fragment. In particular embodiments, the definition of a “close enough” distance is that the center of mass of each fragment is within about 0.1 and 0.5 Ångstroms from a preselected base fragment. In embodiments, fragments are put into a clump if the center of mass is within about 0.25 Ångstroms from a preselected base fragment. The definition of “similar orientations” is that the fragments are within about 0 to about 15 degrees in any direction from a base fragment. In other embodiments, the center of mass is within about 15 degrees in any direction from a preselected base fragment. In other embodiments the definition of “similar orientations” is that the RMS deviation of the atoms in Ångstroms among a set of fragments is less than a selected value. In embodiments, the energy value for a representative fragment of a clump will be the lowest energy value of all the fragments in the clump.

The representative fragment formed from the clump may or may not have features that correspond to an actual fragment that is a member of a clump.

Distribution

A distribution is defined as the clumps of the same fragment type with greater than or equal free energy values with a center of mass within a user defined distance.

Macromolecule

A “macromolecule,” as used herein, is a molecule that contains at least one ligand binding site. Macromolecules include, but are not limited to, polypeptides, polynucleotides such as RNA and DNA, and natural and artificial polymers.

Macromolecular Binding Site

A macromolecular, e.g., polypeptide, DNA, or RNA, binding site is defined as a location on the macromolecule to which a ligand binds. In embodiments, the macromolecular binding site is used to limit the amount of data analyzed. When clumping is performed, fragments that are not within the binding site are optionally ignored.

Group

A group is defined as a collection of distributions defined by various means within the software, including proximity to a residue, another fragment, or selection from a list.

Protein or Polypeptide

As used herein, the term “polypeptide” encompasses a molecule comprised of amino acid molecules linked by peptide bonds, and includes such molecules, regardless of the number of amino acids in the molecule. The term polypeptide, as used herein, also includes molecules which include other moieties in addition to amino acids, such as glycosylated polypeptides, e.g., antibodies. The term polypeptide, as used herein, also includes protein molecules which include more than one chain of amino acids linked by peptide bonds; the multiple chains may be covalently bonded to each other by means of disulfide side-chain bonds.

Free Energy

As used herein, the term “free energy” can either be the Helmholtz free energy: A=U−TS, where A is the Helmholtz function, T is the absolute temperature, and S is entropy, or the Gibbs free energy: G=H−TS, where G is the Gibbs function, H is enthalpy, T is absolute temperature, and S is entropy.

Fragments

“Fragments,” as the term is used herein, includes molecules or molecular fragments (e.g., radicals) that can be used to model one or more interactions with a macromolecule, such as the interactions of carbonyls, hydroxyls, amides, hydrocarbons, and the like. Examples of useful fragments include, but are not limited to:

| Name | Structure |
|---|---|
| Acetone | CH₃(C═O)CH₃ |
| Aldehyde | H(C═O)—CH₃ |
| Amide | H(C═O)NH₂ |
| Ammonia | NH₃ |
| Benzene | 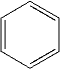 |
| Carboxylic Acid | CH₃COOH |
| 1,4-Diazine | 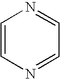 |
| Ester | CH₃—O—(C═O)—CH₃ |
| Ether | CH₃—O—CH₃ |
| Formaldehyde | H₂C═O |
| Furan | 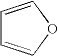 |
| Imidazole | 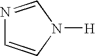 |
| Methane | CH₄ |
| Methanol | CH₃OH |
| Phospho-Acid | 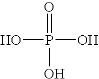 |
| Pyridine | 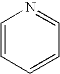 |
| Pyrimidme | 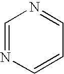 |
| Pyrrole | 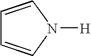 |
| Thiol | CH₃SH |
| Thiophene | 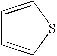 |

Optionally, the fragments selected are representative of chemical features that have proven useful in the design of pharmaceuticals or other bioactive chemicals. Additional fragments will be readily apparent to one skilled in the art.

A database of organic fragments, which are relevant for drug discovery, has been compiled by extracting organic fragments from the molecules. See, for example, 1) Journal of Medicinal Chemistry from 1991-2001, 2) Journal of Heterocyclic Chemistry from 1981-2001, 3) Medicinal Research Reviews from 1991-2001 and/or 4) heterocyclic chemistry text books (for example, Eicher, T.; Hauptmann, S. The Chemistry of Hetero-cycles; Thieme Organic Chemistry Monograph Series: 1995) and/or other journals and/or texts covering biologically active molecules all of which are incorporated herein by reference in their entireties. The compiled database is regularly augmented with new fragments from the literature, from new information garnered about macromolecules gained from the simulations that described herein, and from modifications that a chemist would design for issues such as synthetic tractability.

Introduction and Overview

In embodiments, the present invention provides methods and systems to analyze and interpret fragment positions from computer-implemented simulations of a macromolecule, such as a polypeptide, and a plurality of fragments. Output from the computer simulations can be a set of fragment locations and orientations and free energy values corresponding to the fragment positions and orientations.

The large number of fragment positions and orientations collected in the computer simulation is optionally reduced to eliminate duplicates or near-duplicates and thereby reduce the data. The invention includes an optional method of counting the number of duplicates eliminated.

Moreover, the present invention provides methods of reducing the data output from a simulation between a macromolecule and a large number of fragments of the same type. For example, a macromolecule is simulated with a large number of one type of fragment. Output from the simulation includes fragment positions in relation to the polypeptide. In instances, fragments are close to one another in proximity and have similar orientations. It is desirable to reduce the number of fragments by assigning one representative fragment to a group of fragments having similar orientations and which are close in proximity.

Fragment data is optionally received from more than one computer simulation of a plurality of fragments and a macromolecule. For example, a series of simulations are run between various types of fragments and a polypeptide to determine free energies of binding between the fragments and the polypeptide. Specifically, in a first simulation, a plurality of computer representations of a first type of molecular fragment (e.g., “fragment A”) are placed in proximity to a computer representation of a polypeptide to determine, among other things, candidate binding sites and the free energies of binding between the fragments and the polypeptide. In a second such simulation, a plurality of computer representations of a second type (e.g., “fragment B”) of molecular fragment are placed in proximity to a polypeptide and the same determinations are made. In particular embodiments, consensus sites are those sites where a variety of types of fragments, e.g., fragment A and fragment B, consistently bind. In embodiments, consensus sites are candidate sites for ligand binding. As discussed below, polypeptide sites where water binds are optionally excluded from the candidate binding sites.

A large amount of data results from each simulation of each fragment type. In order to reduce the amount of subsequent analysis, it is advantageous to reduce the data such that fragments that are close to each other and have similar orientations are clumped into one representative fragment. Because individual fragments are the “building blocks” of the ligands of the present invention, reducing the number of fragments can save considerable time and increases the efficiency of the ligand design process.

Accordingly, in embodiments, the data reduction process involves a clustering algorithm that is used to group fragments into clumps based on their translational position and their orientation in space. The clumping process starts with selection of a seed fragment, which may be the first fragment in the data. Fragments around the seed fragment are examined and are added to the clump if they are within the specified clumping distance and if the maximum angle deviation from a preselected fragment is between a specified range.

Following the formation of clumps and a representative fragment of the clump, clumps can be combined into distributions on the basis of similar energy and close proximity. Thus, locations with a higher density of representative fragments with similar energy yield distributions that contain more representative fragments than a distribution formed in a different location with fewer representative fragments with similar energy that are not in close proximity.

Computer Simulations of Fragments and a Polypeptide

Various computer simulation methods that can be used in conjunction with the present invention are disclosed in U.S. Pat. No. 6,735,350, issued May 11, 2004, U.S. application Ser. No. 09/722,731, filed Nov. 28, 2000 and U.S. application Ser. No. 10/794,181, filed Mar. 8, 2004, all of which are incorporated by reference herein in their entirety. The invention is not, however, limited to the simulation methods disclosed in these references. Based on the teachings herein, one skilled in the relevant art(s) will understand that additional computer simulation methods can be employed.

In embodiments, computer simulations used in conjunction with the present invention calculate the free energy of interaction between a plurality of fragments and a polypeptide. In embodiments, the number of fragments are allowed to vary during the time of the simulation. As the simulation progresses, the chemical potential of the system (“B”) is systematically decreased, the result being that the number of fragments decreases with decreasing B, wherein only those that are tightly bound to the polypeptide remain upon completion of the simulation to low B value.

At each value of B, a number of fragments are present in the simulation. In embodiments, a plurality of simulations are run for a variety of fragment types such that a consensus binding site can be determined. If more than one fragment type binds to a particular site, that site is deemed a potential protein ligand binding site.

Formation of Clumps

Following the simulation between the macromolecule and the fragments, a large amount of data is output from the simulation. For example, if implementing the method described in U.S. Pat. No. 6,735,350, between about 20 and 150 fragments are present in the initial simulation. At each chemical potential value (“B value”), progressively less, but a substantial number, of fragments are present in the simulation, and at least about 20 B values “chemical potentials” are run for any given simulation.

Prior to clumping, described below, the number of fragments can optionally be reduced by filtering fragments in a variety of ways. Accordingly, in embodiments of the methods of the present invention, the large amount of data from the computer simulation is further reduced in the present invention by allowing definitions of “binding sites” that focus the attention of the software to a particular region about the protein. The binding site is defined by a centroid of a set of atoms in the protein, and a radius. In particular embodiments, analysis of fragments outside the defined binding site are ignored, or excluded from further analysis, thus reducing the computation and memory required for the analysis.

In particular embodiments, the present invention provides methods to choose among any number of binding sites when beginning the study. For example, the binding sites can be stored in a file in the Brookhaven PDB format and are defined and created in separate methods.

In further embodiments of the present invention, water binding sites are also optionally excluded from the potential binding sites, and fragments that bind in those sites are not analyzed for their ability to form a ligand. In those embodiments, fragments in these locations are ignored on the basis that the tightly bound water occupying that location cannot be displaced by a ligand.

In certain embodiments, after the filtering by binding site, the fragments for analysis can be further reduced by using a binding energy criteria for loading fragments. In general, the lowest binding energy positions of the fragments are the most useful for drug design, and the highest binding energy positions are not as useful. In particular embodiments, the present invention allows the end user to select criteria for inclusion by energy level.

For example, in embodiments it is advantageous to use fragments that are tightly bound to the macromolecule to build the pharmacophore of the ligand, whereas fragments that are not in the pharmacophore of the ligand are advantageously used as linker groups. Linker groups are those groups which connect the pharmacophore fragments; the linker groups themselves do not participate in binding to the macromolecule.

Even after optionally filtering fragments based on the above criteria, the resulting data for any given simulation can be duplicative, and fragments that are close to each other in the simulation can be consolidated into one “representative fragment.” It is advantageous to reduce the number of fragments in the simulation by removing such duplicates, or near duplicates. An advantage of reducing such duplicates, or near duplicates, is that subsequent computational steps, e.g., building molecules from the representative fragments, consumes less time.

Accordingly, from one to thousands of fragments are “clumped” together to form a single representative fragment. In particular embodiments, the method of clumping can comprise identifying molecular fragments that are close to each other in three dimensional space that have similar orientations, and combining each of the identified fragments into a representative fragment. In embodiments, one or more features of the fragments that are clumped are averaged and one or more averaged features are assigned to a representative fragment of the clump. Such features include, but are not limited to, (a) average orientation, (b) energy, (c) potential energy, (d) total energy and (e) “B” value.

In embodiments of the present invention, fragments are defined to be close to each other in three dimensional space when the center of mass of each fragment is within between about 0.1 and about 0.5 van der Waals radius of a preselected base fragment.

In embodiments of the present invention, fragments are defined to have similar orientations when the fragments are between about 0 and about 25 degrees in any direction from a preselected base fragment.

In embodiments, clumps are defined in such a way that accuracy is not compromised. For example, the program will find the same molecule combinations looking at the raw data as the data after the clumps are formed, but fragment/protein positions are visited no more than necessary. In embodiments, fragments are included in a given clump if the bond angles and bond distances of any possible bond atom are all within a given tolerance. Tolerances for bond angle and bond distance derive from the minimum bond distance and angle tolerances used during bonding of fragments to form a ligand. Preferably, the bond angle tolerance (“BAT”) is ±25°, ±20°, ±15°, or ±10°, from an ideal bond angle, and the bond length tolerance (“BLT”) is ±35 Å, ±30 Å, ±25 Å or ±20 Å, compression/tension from an ideal bond distance.

For the purposes of determining BAT and BLT, the vector between a bond atom and an attached hydrogen is used to define the ideal bond angle, and an ideal bond distance of from about 1.48 Å to about 1.62 Å is used, in embodiments of the present invention, a bond distance of 1.54 Å is used.

The values for BAT and BLT represent a spread of distances and angles around the arbitrary ideals that encompass the real distances and angles that would be computed via a more expensive calculation means, such as a quantum mechanics calculation.

Given the BAT and BLT values, in embodiments the fragments of a continuous fragment distribution are grouped together such that the difference in position between successive clumps represents no more than a pre-selected value in bond angle of any bond atom in the fragment. For example, assuming that the difference in position between successive clumps represents no more than a 15° change in bond angle of any bond atom in the fragment, and assuming an ideal bond length of 1.54 Å, the positional tolerance (angular positional atom tolerance (“APT”)) of any bond atom satisfying the above angle criteria is:
APT=RADIANS(15°)*1.54 Å=0.403 Å

For this example, therefore, to assure continuity in clumps given continuity in the underlying sample data, the center of masses of all of the bond atoms in successive clumps must be displaced by no more than about 0.403 Å with respect to the initial seed fragment.

In embodiments, initially the clumping program has a clump list that contains no members, except for a “seed” position of the clump, against which sample fragments are compared. Eventually, each clump will contain a list of fragments that are “members” of the clump.

In particular embodiments, the search pass performs the following algorithm at each sampled position in the simulation as follows:

First, the data-structure (e.g., octree) is searched for clumps that are close to this sampled position such that this sampled position could be in one of them. In embodiments, “close” is defined as a center-of-mass displacement within one BLT of this sampled position.

Second, for each clump that has been defined as “close” in the first step, if all of the bond atoms of the new sample are within APT of the seed position of the clump, add the new sample to the membership list of the clump and move on to the next sample in the file.

Third, if no clump can be found to which the sample could be a member the sample is the seed of a new clump, and the center of mass of this seed is inserted into the data-structure (e.g., octree).

Fourth, the first, second and third steps are repeated for each sample in the file.

In embodiments, once the samples are separated into clumps, the program will compute (a) average center of mass of each clump; (b) average orientation of each clump; (c) B value of each clump; (d) potential energy of each clump; and (e) the total energy of each clump. Depending upon the sampling method used, average center of mass and orientation may be weighted by an energy term. The method used to compute B, potential energy and total energy of each clump is specific to the sampling method used to create the original data.

In embodiments, after clumping is completed, the program optionally (a) computes the solvent-accessible-surface-area (SASA) for the average position of each clump; (b) writes out the clumps to disk; (c) writes out the list of samples in each clump to disk; and/or (d) writes out the information in the data-structure to disk.

As discussed above, in embodiments, following the formation of representative fragments via the clumping process, an energy is assigned to the representative fragment. The energy of the representative fragment can be assigned in a number of ways. As noted above, the average energy of all of the fragments in the clump can be the assigned energy value. Alternatively, in particular embodiments, the energy can be the lowest energy observed between the fragments making up the clump.

Alternatively, or additionally, energies are assigned using their population densities. This can be performed with, for example, a linear Monte Carlo technique. The simulation method of linear Monte Carlo is described in U.S. application Ser. No. 10/794,181, filed Mar. 8, 2004, incorporated herein by reference in its entirety.

In embodiments, a linear Monte Carlo method can be used to compute the energy of the representative fragment. The starting point for the data interpretation is the relation linking the linear Monte Carlo data to the association constant Kₐ characterizing the binding of the considered molecule to a given region on the protein. The association constant Ka characterizes the equilibrium of the binding process:
F+PFP (1)
and is defined by

$${K}_{a} = \frac{[ FP ]}{[ F ] [ P ]} . \qquad ( 2 )$$

Where [P], [F], and [FP] are respectively the concentrations of protein alone, ligand alone, and of a particular protein-ligand complex (binding mode). The association constant is the basic biologically relevant quantity.

In the case of the linear Monte Carlo system, a single protein is considered in a volume V. For the sake of the following discussion, V is taken to be relatively large, although for the actual simulation this does not need to be the case. The protein concentration is therefore given by [P]=1/V. One furthermore notes n is the average number of ligands in the binding volume ΔV_{b} (in general a volume with limits both in translational and orientational space), and N is the average total number of ligands in the system, so

$${K}_{a} = \frac{n / V}{( N - n ) / V \cdot 1 / V} \approx V \frac{n}{N} , \qquad ( 3 )$$

Under the assumption of high dilution, i.e., n<<N. This assumption is valid in virtually all biochemical situations. In binding assays the concentration of the ligand is often nanomolar or less. The values n and N can be obtained from the ligand density. E(Y) represents the protein-ligand interaction energy, β is 1/kT where k is Boltzmann's constant.

$$\begin{matrix}n = {\int }_{Δ {V}_{b}}^{} {f}_{gc} ( Y ) ⅆ Y = \frac{exp ( B )}{V σ} {\int }_{Δ {V}_{b}}^{} exp [ - β E ( Y ) ] ⅆ Y & ( 4 ) \\ N = {\int }_{Δ V}^{} {f}_{gc} ( Y ) ⅆ Y = \frac{exp ( B )}{V σ} {\int }_{Δ V}^{} exp [ - β E ( Y ) ] ⅆ Y \approx exp ( B ) , & ( 5 )\end{matrix}$$

Having again invoked the assumption of high dilution, so that the total system volume V is much larger than the effective region of interaction between the ligand and the protein and thus one may consider E(Y)≈0 when deriving equation (5). The volume of orientational space is represented by σ. The association constant now becomes:

$${K}_{a} = \frac{1}{σ} {\int }_{Δ {V}_{b}}^{} exp [ - β E ( Y ) ] ⅆ Y \qquad ( 6 )$$

On the basis of equation (6) one can also write the association constant in terms of the free-energy of binding
Kₐ=Vσ exp[−βΔA] (7)
where A_{FP} and A_{F} are free-energies of the ligand-protein complex and of the ligand alone, respectively:

$$\begin{matrix}{A}_{FP} = - \frac{1}{β} log ( {\int }_{Δ {V}_{b}}^{} exp [ - β E ( Y ) ] ⅆ Y ) , & ( 8 ) \\ {A}_{F} = - \frac{1}{β} log ( {\int }_{ V}^{} ⅆ Y ) = - \frac{1}{β} log ( V σ ) . & ( 9 )\end{matrix}$$

The critical “B value,” associated with the binding volume, is defined as being the value for which the average number of ligands in the binding site equals to one. From equation (4) then follows

$$n ( {B}_{c} ) = 1 ⇔ exp ( - {B}_{c} ) = \frac{1}{V σ} {\int }_{Δ {V}_{b}}^{} exp [ - β E ( Y ) ] ⅆ Y \qquad ( 10 )$$

and from (6), (7) and (10) one finally obtains

$$\begin{matrix}{K}_{a} = V exp [ - {B}_{c}^{′} ] = {V}_{0} exp [ - {B}_{c} ] & ( 11 ) \\ Δ A = \frac{1}{β} {B}_{c}^{′} = \frac{1}{β} ( {B}_{c} - log \frac{{V}_{0}}{V} ) . & ( 12 )\end{matrix}$$

The critical value can be computed using definition (10):

$$1 = n ( {B}_{c} ) = \frac{1}{{n}_{snap}} {\sum }_{i = 1}^{{n}_{snap}} {\sum }_{frag j ∈ Δ {V}_{b}}^{} exp [ {B}_{c} - {B}_{num} ( {Y}_{j} ) ] \\ c \\ {B}_{c} = - log ( \frac{1}{{n}_{snap}} {\sum }_{i = 1}^{{n}_{snap}} {\sum }_{frag j ∈ Δ {V}_{b}}^{} exp [ - {B}_{num} ( {Y}_{j} ) ] ) \qquad ( 13 )$$

Equations (11), (12) and (13) provide the basic relations on how the data is to be interpreted to compute the energy level in units of B for each clump.

Representative Fragment Selection and Formation of Distributions

In particular embodiments of the present invention, following the formation of a plurality of clumps, the clumps are gathered together in distributions. A distribution defines a set of clumps with the same or similar energy levels in proximity to one another. The proximity required to define a distribution, the “distribution radius,” is user-adjustable.

Prior to the formation of a distribution, in particular embodiments it is desirable to further reduce the amount of data, i.e., reduce the number of fragments used to form the distribution by filtering the representative fragments in a variety of ways.

Accordingly, in embodiments of the methods of the present invention, the large amount of data from the computer simulation is further reduced in the present invention by allowing definitions of “binding sites” that focus the attention of the software to a particular region about the protein. The binding site is defined by a centroid of a set of atoms in the protein, and a radius. In particular embodiments, analysis of fragment clumps outside the defined binding site are ignored, or excluded from the distribution, thus reducing the computation and memory required for the analysis.

In particular embodiments, the present invention provides methods to choose among any number of binding sites when beginning the study. The binding sites can be stored in a file in the Brookhaven PDB format and are defined and created in separate methods.

In particular embodiments of the present invention, water binding sites are optionally excluded from the potential binding sites, and representative fragments which bind in those sites are not analyzed for their ability to form a ligand. In those embodiments, fragments in these locations are not used for building molecules and are ignored on the basis that the tightly bound water occupying that location cannot be displaced by a ligand.

In certain embodiments, after the filtering by binding site, the clumps (i.e., representative fragments) for analysis can be further reduced by using a binding energy criteria for loading the representative fragments. In general, the lowest binding energy positions of the fragments are the most useful for drug design, and the highest binding energy positions are not as useful. In particular embodiments, the present invention allows the end user to select criteria for inclusion by energy level.

For example, in embodiments it is advantageous to use representative fragments that are tightly bound to the macromolecule to build the pharmacophore of the ligand, whereas representative fragments that are not in the pharmacophore of the ligand are advantageously used as linker groups. Linker groups are those groups which connect the pharmacophore fragments; the linker groups themselves do not participate in binding to the macromolecule.

In particular embodiments, representative fragments are grouped into three categories according to energy level. In some molecular simulations that can be used in conjunction with the present invention, in the beginning of a simulation between a macromolecule and a plurality of fragments, the macromolecule is bathed in fragments, deemed the “bulk” regime. In the bulk regime, the entire periodic box is filled with fragments, many of which are at high energy. For example, if a molecular simulation according to the method of U.S. Pat. No. 6,735,350 is run, starting at high potential energy, e.g., B=+10, the entire simulated periodic box is filled with fragments. As the potential energy of the system is decreased, fragments are allowed to leave the simulation, and those with the least energetically favorable interactions with the protein, or optionally with other fragments, leave the simulation.

Therefore, in certain embodiments, the present invention allows optionally loading bulk fragments for analysis, i.e., loading those fragments that remain at a B level that is less than zero, but 50% of the highest simulated free energy (“B”) levels and at, or some or all of these fragments are ignored.

The “linker” group is intermediate between “bulk” and the lowest energy “core” group. In embodiments of the present invention, the linker group typically comprises fragments that remain at a B level that is less than about 5 and remain at a B level that is typically within a user adjustable percentage of the highest simulated B level. The linker group is defined as the group consisting of at least one fragment that is not a part of the pharmacophore of the molecule being built. The linker group connects the portions of the molecule that do participate in the pharmacophore.

The “core” group of fragments are expected to form the pharmacophore because such fragments are most tightly bound to the polypeptide. In embodiments of the present invention, the “core” group of fragments remain at a B level of less than about −5 and remain at a B level that is typically within about 25% of the B levels for each fragment. These categories are chosen for each fragment and due to the nature of a given simulation, the percentages and B levels may be different for each fragment.

Clumping collapses all B values together, and the energy of the representative fragments is selected as the lowest B level present in each clump as an estimate of where the simulated annealing “boiled off” the fragments. This point is proportional to the local free energy of the fragments in the nearby volume. For example, as discussed above, the orientations and energies of linker fragments may be obtained at a higher B value than the orientation and energy of the core fragments.

In addition to the other filters, the present invention provides methods of filtering clumps by their solvent-accessible-surface-area. The solvent-accessible surface area can optionally be pre-computed for each clump at the same time as the clumping operation. In embodiments, a user interface element allows selection of fragments by percentage of exposed surface area. This allows the user to quickly differentiate surface-bound fragments from those embedded in binding pockets, and allows limiting building to those embedded fragment clumps.

Molecular Design

In particular embodiments, the present invention also provides methods of binding representative fragments from particular clumps to form ligand candidates. For example, once the clumps are created and each clump has been assigned a representative fragment position and orientation, the representative fragments are then analyzed for their potential to bond to each other. In certain embodiments, the criteria for bonding are as follows. For example, a bond between two fragments is made along the vectors described by hydrogen atoms in the fragments. If the hydrogen-atom-vectors of two fragment instances, of the same or different chemical type, are aligned in space within some tolerance the two fragments are candidates for bonding. The typical parameters to allow bonding are that the heavy atoms are at a distance typical of a bond, for example, between about 1.00 Å and 2.25 Å of each other. In further embodiments, the heavy atoms are about 1.5 Å apart.

In particular embodiments, in making the determination that a representative fragment from a particular clump can bind to a representative fragment from a second clump, a second parameter is also included. For example, if a vector between hydrogen atoms in the first and second representative fragment is substantially linear, and all other bonding criteria have been met, the first and second fragments are selected to bond.

In embodiments, “linear” is defined by the angle between the heavy atom of the first fragment, the heavy atom of the second fragment, and the hydrogen attached to the heavy atom of the second fragment. The vector is linear if the angle is between about 0° and about 15°. For example, if the angle defined by the heavy-atom of one fragment, the heavy atom of the second fragment, and the hydrogen attached to the heavy atom of the second fragment are close to zero within a tolerance, typically from 0 to 15 degrees, and preferably 15 degrees, the fragments are determined to be candidates for bonding. Any two fragments that are situated to allow any of the multitude of hydrogens to align in this manner are considered candidates for bonding. This process is repeated as necessary, on demand, to build a list of all the bond candidates in the defined binding site.

Another building mode, in addition to the connection along hydrogen atoms, is merging methyl groups in proximity to each other. In this building mode, if two methyl groups are in a selected proximity, one of the methyl groups is removed, the hydrogens from the other methyl group are removed, the carbon from the second methyl group is bonded to the atom that the first carbon atom was bonded to, and the hydrogen atoms are re-added in positions designed to be as close as possible to ideal.

In particular embodiments, as a way to more effectively satisfy the building modes, the hydrogen atoms of methyl groups may be rotated about the central carbon to provide better bond angle alignment. Further embodiments rotate free methane and SH, OH and NH groups.

In particular embodiments, once these operations are completed the invention provides computer-implemented methods of constructing molecules. For example, two modes of construction are embodied, a user-guided mode and an “autobuild” mode. These two modes can be combined in various ways.

In the user-guided mode, molecules can be built by selecting any clump of any group of fragments. Then the list of all clumps that can be bonded to the selected clump are presented and the user can elect to create a molecule by bonding a clump to the original clump. This process can be repeated to connect any desired number of clumps.

In an unconstrained autobuild the user filters the fragments using the criteria described, then selects all or a subset of fragments with which to build molecules. The user then specifies a minimum and maximum number of fragments with which to build molecules, and a minimum and maximum molecular weight for the resulting molecules, and the maximum number of molecules to store. The program then systematically assembles all possible combinations of the fragments and stores the desired number of lowest energy examples.

In the constrained autobuild the user can select sets of groups that must be included in a build, and a set of groups that may be included in building molecules. The user selects a minimum number of these optional groups. In addition the metrics of minimum and maximum number of fragments, and minimum and maximum molecular weights are applied to the build process. In this way it is possible to specify fragments defining a pharmacophore, i.e., the section of the structure of a ligand that binds to a receptor, and identify all possible methods of linking them into a molecule. Alternatively, using the optional groups it is possible to identify many pharmacophore elements and identify all possible molecules that can connect a specified subset of these elements into molecules.

Calculating and Sorting Molecular Properties

As discussed, the present invention provides methods of designing protein binding ligands by linking or bonding computer representations of molecular fragments to form a plurality of ligands. In particular embodiments, the present invention includes calculating at least one energy of interaction between the protein and the plurality of ligands and sorting the plurality of ligands by the energy of interaction between the protein and the ligand. In certain embodiments, the interaction energy between the ligand and the protein is calculated by summing the energies of interaction between the protein and each molecular fragment that comprises the ligand.

Further embodiments of the present invention include calculating and/or sorting molecules by additional properties. Such information can be stored in and retrieved from commercial database software. The following list includes properties that can be calculated and used to sort ligands to aid in determining their candidacy for further investigation:

3D Molecule ID—molecule identifier

Molecule Name—molecule name

Number of Fragments—number of fragments used to make the molecule

B Value—Locus predicted affinity

Molecular Weight—molecular weight

LogP C2—logp calculated using Cerius2 AlogP (Accelrys)

LogP QP—logp calculated using QikProp (Schroedinger)

Drug-like Score—a drug likeness score derived through a model

Rp Drug Category—a drug likeness recursive partition model

Rp Category #—the category number assigned to a molecule from a recursive partition model

Rp Class #—the recursive partition class assigned to a molecule from a recursive partition model

Penalty—the penalty score which assesses a molecules drug likeness; this is based on a variety of properties and a comparison of the specific molecule's properties compared to the range of drug molecules

Penalty String—the (string) list of violations for the penalty described above

Close Residues—list of the residues close to the molecule

Rotatable Bonds C2—number of rotatable bonds as calculated in Cerius2 (Accelrys)

Rotatable Bonds QP—number of rotatable bonds as calculated in QikProp (Schrodinger)

Hbond Acceptors C2—number of hydrogen bond acceptors as calc. in Cerius2 (Accelrys)

Hbond Acceptors QP—number of hydrogen bond acceptors as calc. in QikProp (Schrodinger)

Hbond Donors C2—number of hydrogen bond donors as calc. in Cerius2 (Accelrys)

Hbond Donors QP—number of hydrogen bond donors as calc. in QikProp (Schrodinger)

Absorption Level C2—a model which predicts a molecule's absorption level, an ADME predictor

BBB Penetration C2—a model which predicts the blood brain barrier penetration

Solubility C2—prediction of aqueous solubility

Solubility Level C2—categorical (high, low, medium) prediction of aqueous solubility

Solubility QP—prediction of aqueous solubility

Rule of 5 Violations C2—a score which reflect the number of violations from Lipinski's rule of 5 for oral bioavailability

Reactive Func Groups QP—a list of potentially reactive functional groups found in the molecule

CNS Activity QP—a prediction of central nervous system activity

Polar Surface Area C2—calculation of polar surface area

SASA QP—calculation of the Solvent Accessible Surface Area (SASA)

Hydrophobic SASA QP—calc. of the hydrophobic SASA

Hydrophilic SASA QP—calc. of the hydrophilic SASA

PI SASA QP—calc. of the SASA for the regions of the molecule which have pi character

Weakly Polar SASA—calc. of the weakly polar SASA

SA Volume QP—calc. of the solvent accessible volume

BI Caco-2 Permeability QP—a QikProp model to calculate Caco-2 permeability (one of several models) as a surrogate to predict absorption

Affy Caco-2 Permeability QP—a QikProp model to calculate Caco-2 permeability (one of several models) as a surrogate to predict absorption

Affy MDCK permeability QP—a QikProp model to calculate MDCK permeability as a surrogate to predict absorption

Log Brain/blood QP—a predictor of the blood brain barrier penetration

Likely metabolic reactions QP—rule based model to provide potential metabolic sites on a molecule

Log Khsa QP—a predictive model as a surrogate for human serum albumin binding

Missing ADME values—missing ADME values which could not be computed for any given reason

In embodiments, C2 properties are calculated using the program Cerius2 from Accelrys Inc.; while QP are properties calculated using QikProp from Schrodinger Inc.

The following properties are based on some post-processing calculations performed on the designed molecule in the presence of the protein as well as the molecule alone. They are used to compare positions and energies before and after these post-design energy minimizations.

RMS deviation between minimized structures in contact with the protein vs out of protein

Maximum movement of any atom between minimized structures in contact with the protein vs out of protein

Energy computed in contact with the protein

Energy computed without contact with the protein; the internal energy of the ligand.

Energy of the minimum energy pose outside the protein.

Energy Out-In: The energy difference between the energies computed in contact with the protein, and the minimum energy pose not in contact with the protein.

Computer Algorithm

In embodiments of the present invention, the following algorithm can be used to implement the methods of the present invention.

Introduction

The process of building molecule geometries from rigid fragment simulations involves two processes:

1. Explore the chemical diversity of the fragments selected for simulation by iterating through the various permutations of connecting fragments—bonding heavy atoms with free valences, merging methyl groups, etc.

2. Explore the 3D structure of accessible fragment combinations by evaluating the geometry of the connected atoms and filtering out any fragment combinations with “unrealistic” bond geometry.

The “traditional” algorithm used to “build” molecules has been:

1. Cycle through all the 3D positions in the simulation, or through the 3D positions selected by the user.

2. At each position, find all the positions of fragments geometrically “near” the current position.

3. Evaluate the chemical diversity of the current position and the nearby fragments.

4. Recurse on the fragment combinations (“poses”) with valid geometry.

The “traditional” algorithm evaluates chemical diversity at every fragment position, and will allocate memory to store the positions of every atom of every valid pose.

Amortizing Across the Ensemble

Instead of performing each test serially, as the “traditional” algorithm, the present algorithm “amortizes across the ensemble” meaning that any test that is performed in an identical way for the various poses of an ensemble is done all at once for all of the poses in the ensemble. Any tests that have invariant result across the poses of the ensemble are done once for that ensemble.

In simple terms this means that for the “traditional” algorithm, as each fragment instance is encountered, the algorithm would determine what chemical compounds could be made with that fragment instance and all of the fragment types loaded by applying aforementioned molecular design building modes. For example, if ten fragment instances of fragment type A would each bond with fragment type B C and D, then the “traditional” algorithm would check ten times whether B C and D could be bonded to A, in the 2D chemistry sense. This check, probing chemical diversity, only needs to be done once for each chemical possibility, not for each geometric possibility. If the molecular design building rules determine that A can bond to B at atoms (2,2) and (3,4), then individual geometries from the fragments in the simulations may be evaluated separately.

The present algorithm works this way. Chemical diversity is analyzed first, and then multiple geometries are evaluated for each possible chemical compound. In addition, there are other cases where the algorithm does similar amortization, such as determining whether a particular chemical compound meets the atomic weight criteria, or the number of fragments criteria, the check is done on the compound rather than the pose.

Implicit Storage of Molecule Poses

The “traditional” algorithm will, for every molecule pose built, store the position and atom type of every single atom and every single bond. Considering that on average there are >10 poses of each chemical compound in the built molecules, there is the potential for a great deal of savings.

The present algorithm creates bond trees, described below, for each chemical compound, and a minimal amount of storage is used to represent each pose. In practical terms, using the methods described herein, the algorithm never explicitly stores poses of molecules in memory, but is capable of generating any desired pose at will.

It does this by treating fragment instances as “flyweights”. See Design Patterns, Gamma, Help, Johnson Viissides, ISBN 0-201-63361-2. For example, if 10 fragment instances of fragment type A are joined to 10 fragment instances of fragment type B at atom 2 of A and 4 of B via a single bond, and that every instance of A is joined to every instance of B. Rather than explicitly storing 100 copies of A and B, modified to depict the bond between atom 2 and atom 4, the present algorithm stores a structure that has a list of A's, a list of B's, the bond atoms, and can generate any of the 100 poses on-demand.

There are two major advantages to this approach. First, memory usage is now proportional to the amount of simulation data loaded—no longer proportional to the combinatorics of the poses found in the data. Second, by pointing to the fragment instances in the simulation when generating poses, the working set of fragments for a particular ensemble are stored in memory exactly once and are more likely to be resident in-cache on a modem processor.

Generic Functions and Bond Trees

The search problem that the algorithm is trying to solve may be conceptually subdivided in a similar way. The “traditional” algorithm was organized around the idea of finding molecule poses.

For example, imagine two fragments, fragments A and B, that have been run in separate free-energy grand canonical Monte-Carlo simulations and chemical compounds and 3D poses present in that simulation data must be found. Furthermore, assume that “interesting” interactions of fragment A with the protein have been found and have grouped a subset of fragment A that exhibits that interesting interaction. All two-fragment compounds and poses that exist within the simulation data are desired.

We can conceive of generic functions that can find ensembles of molecules using a programming system that defines grouping pairs of fragments, doing nearby searches, comparing atom distances, angles, clashes etc.

First, all of the pairs of fragment A and B such that B is close enough to A that some atom of B could be bonded to some atom of A are found:

<1>(define close-pairs

(all-pairs (interesting A) (nearby B)))

<2> (close-pairs)
Result: 574 pairs.

Assume that fragment A has two bondable atoms and fragment B has three bondable atoms. All the possible combinations of bondable atoms in the pairs are cycled through and ensembles where pairs of bondable atoms are close enough to be bonded are sought:

| | |
|---|---|
| <3> | (define close-atoms atomA atomB |
| | (bond-distance-test atomA atomB close-pairs)) |
| <4> | (close atoms 0 0) |
| | Result: 0 pairs |
| <5> | (close-atoms 0 1) |
| | Result: 42 pairs |
| <6> | (close-atoms 0 2) |
| | Result: 0 pairs |
| <7> | (close-atoms 1 0) |
| | Result: 0 pairs |
| <8> | (close-atoms I 1) |
| | Result: 4 pairs |
| <9> | (close-atoms 1 2) |
| | Result: 0 pairs |

There are two plausible ensembles of pairs of A and B that have fragments with atoms that are close enough to be bonded into two different chemical compounds. Note here that 6 steps have been taken to probe diversity, and that all of the comparisons of the same pair of atoms were done together.

The search is further refined by checking the bond angles made by bonding the fragments together at the given pairs. Since we know that only two ensembles had any pairs after the distance check, we only have to check those ensembles for angle:

| | |
|---|---|
| <10> | (define good-angles atomA atomB |
| | (bond-angle-test atomA atomB (close-atoms atomA atomB))) |
| <11> | (good angles 0 1) |

Result: 25 pairs
<12> (good angles 1 1)
Result: 2 pairs

Both compounds still have valid pairs, so the two compounds found so far are still available in the data. We can further check for van der Waals clashes between the fragments:

<13> (doesn't-clash (good-angles 0 1))
Result: 22 pairs
<14> (doesn't clash (good-angles 1 1))
Result: O pairs

Finally, the end result. A single compound has been built in 22 different geometries using the given simulation data, using this function:

(define nice-molecule

(doesn't-clash
(bond-angle--test 0 1
(bond-distance-test 0 1
(all-pairs
(interesting A)
(near B))))))

This end result is the fundamental result of searching for chemical compounds that combine simulation results for fragments A and B. This end result's structure defines a compound, and evaluating all of its values produces the possible geometries found in the simulations.

The fundamental work that the algorithm must do is to identify compounds that are implied by the fragment simulation data—for the algorithm this means finding molecule functions that have ensembles with one or more members given the simulation data.

Representing Compounds As Trees

In the present embodiment of the algorithm, molecule functions described above have been mapped to trees of C++ objects connected in directed acyclic graphs with a single “root” or “top”. The various bond geometry test functions map onto tree nodes with pointers connecting the nodes. For example, here is the “nice-molecule” tree from the previous section:

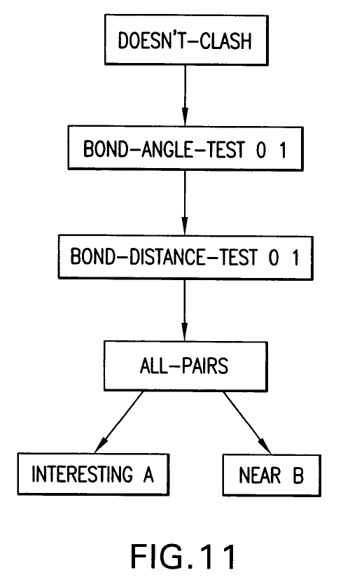

The tree in FIG. 11 represents mapping the previous “nice-molecule” example onto the C++ object structure as a result of the build process. C++ objects are represented as boxes, with arrows connecting the boxes representing the pointers that define the tree. The build process in the present algorithm which creates the above trees is:

1. Build a prospective tree connecting distributions of fragments by iterating over the various possible chemical combinations.

2. Invoke object methods described below on the “top” object in the tree causing the objects in the tree to iterate through the 3D geometries of the simulation until a possible geometry is found that satisfies all of the bond distance, angle and clashing constraints necessary to connect the fragments from the simulations into whole molecules.

3. Discard any trees where no possible 3D geometry could be found that satisfies all of the constraints.

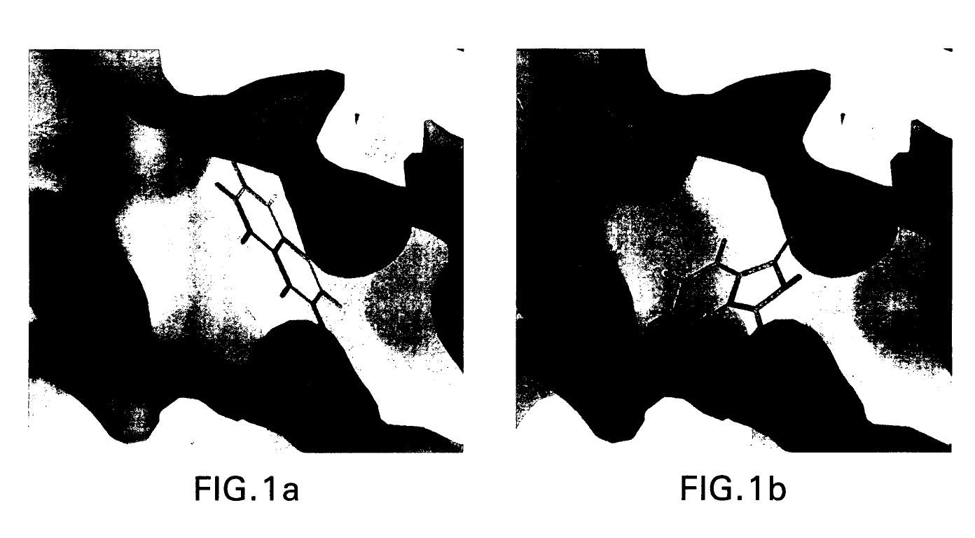

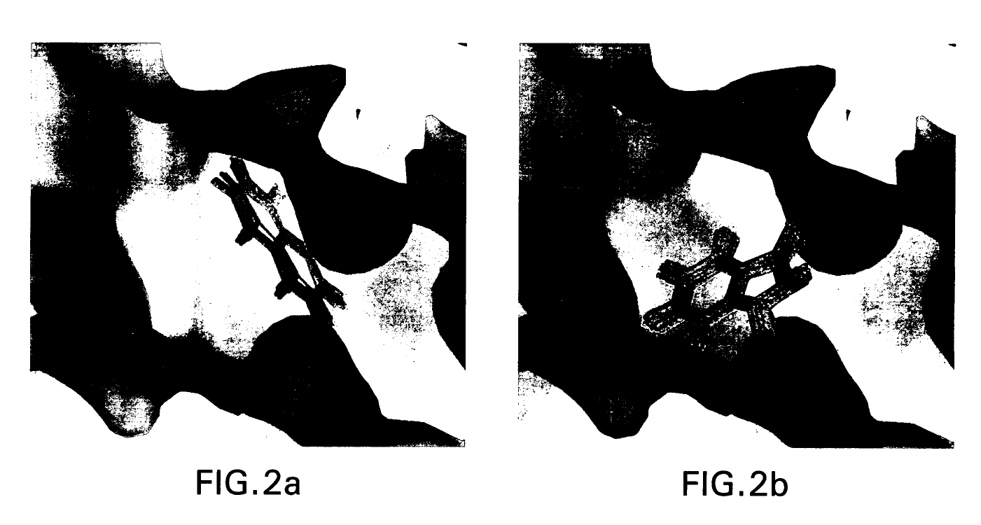

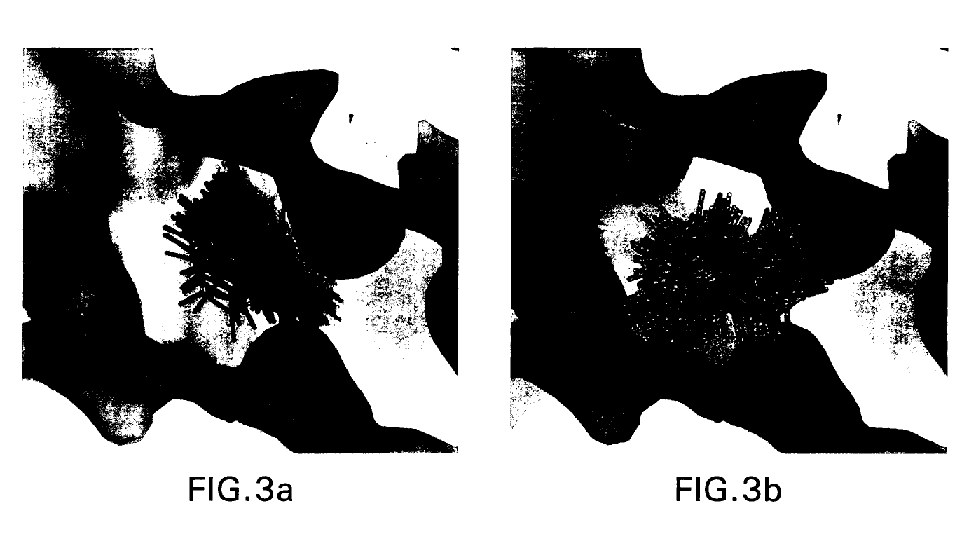

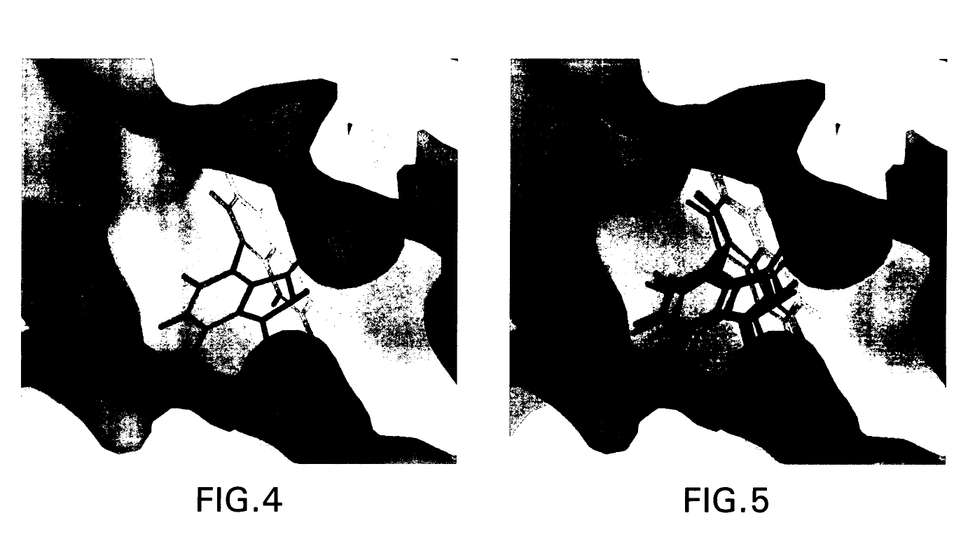

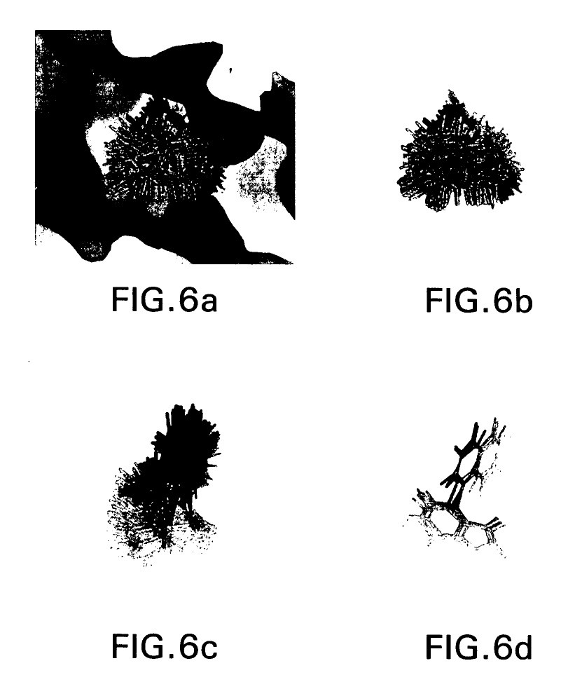

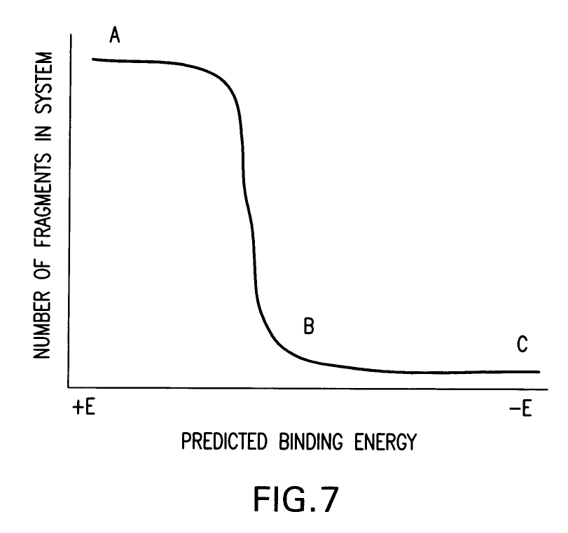

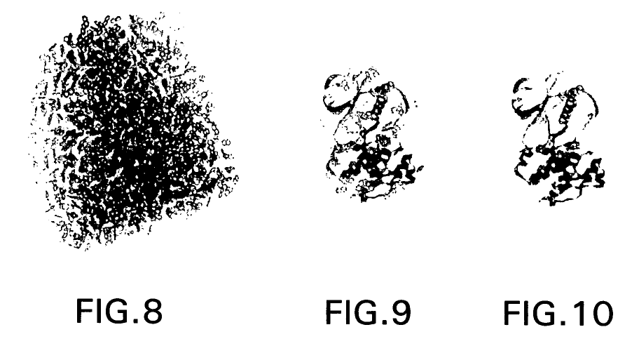

In the tree in FIG. 1, “interesting A” and “near B” represent C++ objects that iterate through parts of the simulation data, the fragments of A being selected as “interesting” by the user and the fragments of B being selected as all the fragments nearby all A fragments. “all-pairs” represents the C++ object that can generate all pairs of A and B. “bond-distance-test 0 1” represents the C++ object that discards any pairs of A and B where atom 0 of A isn't close enough to atom 1 of B to form a valid molecular bond. “bond-angle-test 0 1” represents the C++ object that discards any pairs of A and B where atom 0 of A and atom 1 of B aren't in angular alignment to form a valid molecular bond. “doesn't-clash” represents the C++ object that discards any pairs which have van der Waals clashes between atoms of A and B.

A depth-first visitation of this tree represents the flow of control that the computer program would take to identify geometries of the molecule A-B connected at atoms 0 and 1. As an example, to find the first valid geometry of this molecule, a C++ method call is made to the top-most object requesting the first valid pose, and the following steps would occur:

1. “doesn't-clash” would repeatedly call a C++ method of “bond-angle-test” requesting pairs that satisfy bond angle criteria until “doesnt-clash” found a pair that didn't clash.

2. At each method call invoked by “doesn't-clash”, “bond-angle-test” would repeatedly call a C++ method of “bond-distance-test” requesting pairs that satisfy the bond distance criteria until it found a pair that met the angle criteria.

3. At each method call invoked by “bond-angle-test”, “bond-distance-test” would repeatedly call a C++ method of “all-pairs” requesting pairs of A and B until it found a pair that met the distance criteria.

4. At each method call invoked by “bond-distance-test”, “all-pairs” would invoke methods of “interesting A” and “near B” to enumerate all of the possible pairs of A and B.

These successive method calls through the objects in the tree represent the depth-first visitation of that tree necessary to iterate through the valid molecular geometries of the molecule represented by that tree.

These trees of objects connected by pointers represent the notion of a higher-order function that operates on a particular chemical compound. Such a tree represents the series of operations that are undertaken to produce a set of poses of a particular chemical compound derived from various fragment instances from the individual fragment simulations.

Representing A Distribution

The “interesting A” block in FIG. 11 corresponds to a C++ object that can answer questions about a distribution of fragment instances for a particular fragment type via C++ method calls. In the present embodiment the various questions answered via method calls may be illustrated by examining the interface to the object:

class FragmentSource : public BondingComputation
{
public:

| | |
|---|---|
| virtual const string& | name( ) const; |
| virtual size_t | num_heavy-atoms( ) const; |
| virtual const Atom& | heavy_atom(size_t index) const; |
| virtual int | heavy_atomic_number(size_t index) const; |
| virtual size_t | num_heavy_atom_bonds(size_t atom) const; |
| virtual BondedTo_t | bonded_to(size_t atom, size-t index) |
| | const; |
| virtual size_t | num_hydrogen_bonds(size_t atom) const; |
| virtual const Atom& | hydrogen(size_t atom, size_t index) |
| | const; |
| virtual bool | synthetic_position(size_t atom, |
| | size_t index) const; |
| virtual | center_of_mass( ) const; |
| Vector3D<fragCoord_t> | |
| virtual fragCoord_t | vdWRadius( ) const; |
| virtual fragCoord_t | heavy_atom_radius( ) const; |
| ... | |
| }; | |

In other words, the following information may be desirable: the name of the fragment, how many heavy atoms there are in the fragment, the position and types of the atoms, the bonds, the hydrogen atoms that are bonded to the heavy atoms, geometric center, etc. Some of the above questions have different answers for each fragment instance of the distribution, such as the positions of the atoms and the geometric center, while other questions, such as the number of heavy atoms or the fragment name are invariant with respect to each fragment instance in the distribution.

For the questions above that require an answer that is specific to a particular fragment instance, the class maintains internal state representing the “current” fragment of the distribution (an “iteration position” within the distribution) and a way to advance this iteration position through all the fragments in the distribution. Said iteration is accomplished via this interface:

class BondingComputation

{
public

| ... | |
|---|---|
| virtual void | begin( ); |
| virtual size_t | next (size_t n); |
| virtual bool | done( ) const; |
| ... | |

}

This interface allows iteration through the fragment positions in the distribution so as to find out about the positions of the individual atoms, etc. via the FragmentSource interface.

This iteration interface is the BondingComputation interface.

Combining Two Fragments

Moving up the previous tree, the node labeled “all-pairs” is encountered. Questions are asked about fragments in a pair:

class PairedFragmentsSource : public BondingComputation
{
public:

| | |
|---|---|
| virtual const string& | name_first( ) const; |
| virtual size_t | num_heavy_atoms_first( ) const; |
| virtual const Atom& | heavy_atom_first(size_t index) const; |
| virtual int | heavy_atomic_number_first(size_t index) |
| | const; |
| virtual BondedTo_t. | bonded_to_first(size_t atom, size_t num) |
| | const; |
| virtual size_t | num_heavy_atom_bonds_first(size_t atom) |
| | const; |
| virtual size_t | num_hydrogen_bonds_first(size_t atom) |
| | const; |
| virtual const Atom& | hydrogen_first(size_t atom, size_t num) |
| | const; |
| virtual bool | synthetic_position_first(size_t atom, |
| | size_t num) const; |
| virtual | center_of_mass_first( ) const; |
| Vector3D<fragCoord_t> | |
| virtual fragCoord_t | vdWRadius-first( ) const; |
| virtual fragCoord_t | heavy_atom_radius_first( ) const; |
| virtual const string& | name_second( ) const; |
| virtual size_t | num_heavy_atoms_second( ) const; |
| virtual const Atom& | heavy_atom second(size_t index) const; |
| virtual int | heavy_atomic_number_second(size t |
| | index) const; |
| virtual BondedTo_t | bonded_to_second(size_t atom, size_t |
| | num) const; |
| virtual size_t | num_heavy_atom_bonds_second(size-t |
| | atom) const; |
| virtual size_t | num_hydrogen_bonds_second(size_t atom) |
| | const; |
| virtual const Atom& | hydrogen_second(size_t atom, size_t |
| | num) const; |
| virtual bool | synthetic_position-second(size-t |
| | atom, size-t num) const; |
| virtual | center_of_mass second( ) const; |
| Vector3D<fragCoord_t> | |
| virtual fragCoord_t | vdWRadius_second( ) const; |
| virtual fragCoord_t | heavy_atom_radius_second( ) const; |

This is the same set of questions that are asked about individual fragments in a distribution, except the questions, have been duplicated for each fragment in the pair.

This is the PairedFragmentsSource interface.

The above questions have answers for each pair of fragments in the two distributions. The same BondingComputation interface that the distributions used to iterate over fragment instances is used to iterate over pairs of fragment instances. The “all-pairs” node of the tree in FIG. 11 would be represented by the C++ object called AllFragmentPairs that has a pointer to two FragmentSource objects. AllFragmentPairs uses the FragmentSource interface to two separate fragment distributions to iterate over all of the pairs of those fragment distributions.

AllFragmentPairs introduces some ideas:

Nodes in the trees may be chained together, and these connections are directed and acyclic.

The iteration state at a particular point in the tree is comprised of the iteration states of all nodes below that point in the tree.

Bonding Fragments

The following describes how the algorithm examines fragment pairs in light of a particular bond.

The C++ object SingleBondFilter represents the combination of tests in the nodes “bond-distance-test” and “bond-angle-test” of FIG. 11. SingleBondFilter has a pointer to any node which iterates over pairs of fragments, and checks if making a bond between a particular pair of atoms of each fragment in each pair would meet particular distance and angle criteria. Iterating through the pairs that this node produces yields all of the pairs that meet the distance and angle criteria, but none of the pairs that don't meet the criteria. In addition, some of the answers to the questions about the individual fragments change when asking them of the SingleBondFilter. In particular, when two fragments are bonded together via a single bond between heavy atoms of those fragments, the hydrogen atoms that were bonded to the heavy atoms are removed from the resultant molecule. SingleBondFilter will alter its answers to reflect these changes so that from that point upward in the tree, the fragments appear to be bonded together. There is a different type of C++ object for each possible build rule described in the previous molecular design section.

This yields two more general ideas present in the current embodiment of the algorithm:

Nodes may filter the iteration positions of the tree below them to reflect some additional chemical bond reality.

Nodes may reflect chemical changes as a result of a new chemical bond when presenting the pairs of fragments to nodes above them topologically in the bond tree.

Bonding More than one Atom of a Pair

Sometimes two fragments may be bonded at more than one atom position at the same time. For example, maybe two somewhat linear fragments could be joined together at two places yielding a ring.

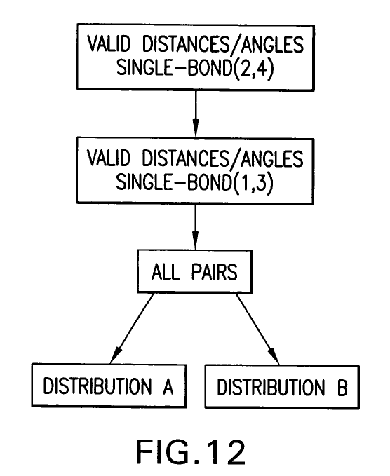

When a tree needs to represent more than one bond on a particular pair, bond filter nodes can be “stacked” so that the output of a lower filter feeds pairs to a higher filter, as shown in FIG. 12. This implements both bonds applied simultaneously to each possible 3D geometry.

Making Molecules with More Than Two Fragments

A molecule is often comprised of more than two fragments paired together, yet the structure so far only supports pairs of fragments. Pairs are chained together by their common fragments using FirstFragmentOfPair or SecondFragmentOfPair to connect together the common fragments. These C++ objects select either the first or second fragment of the pair to which they point. For example, say we have a molecule that connects fragments A, B and C together, with B in common.

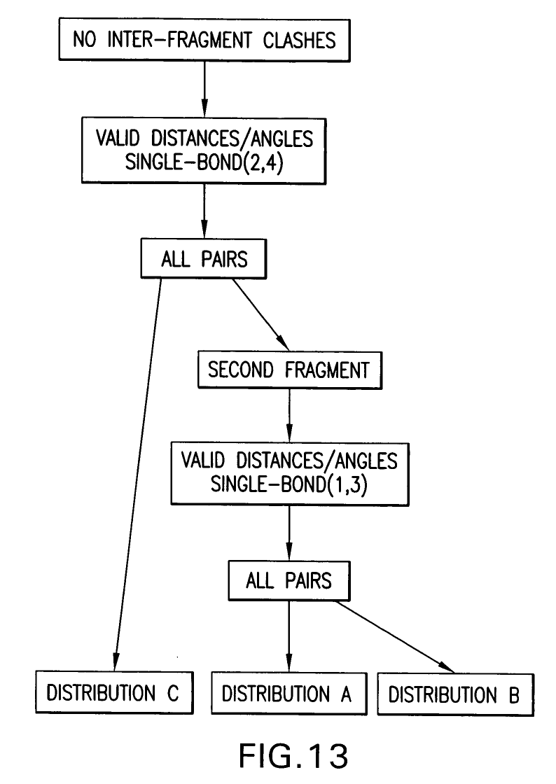

The tree shown in FIG. 13 represents all of the combinations where fragment A and B could be bonded at atoms (1,3) simultaneously with a fragment of C bonded to B at (2,4). Connecting Fragments Into Cyclic Structures

In the previous example, in addition to bonding A to B and B to C, bond C to A is bound simultaneously to form a cyclic structure. In this case, the cycle is represented as a node that “above” all of the other pairs that represents the bonds made to make the cycle:

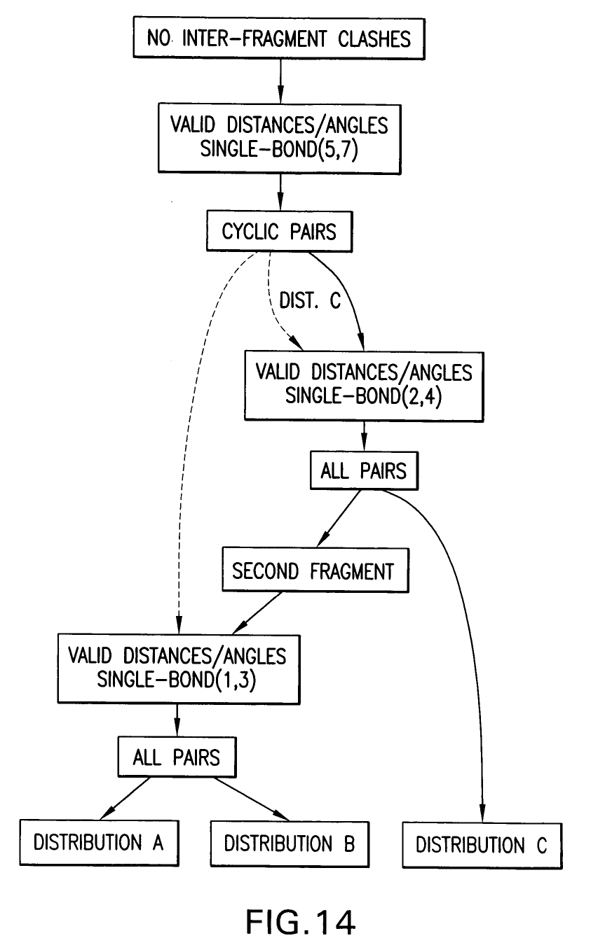

In FIG. 14 we see a new node “Cyclic Pairs” that returns all of the pairs of distribution A returned from the “Single-Bond(1,3)” constraint and distribution C returned from the “Single-Bond(2,4)” node. These pairs are filtered for valid bonds at bond atom 5 of distribution A to bond atom 7 of distribution C.

The dotted arrows represent that the PairedFragmentsSource interface of the CyclicPairs class is passed-through to the indicated nodes. The solid arrow connecting “Cyclic Pairs” to “Single-Bond(2,4)” indicates that the BondingComputation (iteration) interface of the CyclicPairs class passes through to the “rest” of the molecule.

Viewing the Distribution of a Molecule

Looking at the previous example, there's one node at the top of the tree that hasn't yet been explained. So all of the combinations of A, B and C have been found where A−>B−>C have valid bond distances and angles. Now we want to know if A clashes with B, B clashes with C, or C clashes with A. If we don't a-priori know the actual structure of a particular tree, we need to traverse the tree to find all of the fragments in the tree.

The detailed question we want to ask for clashing is as follows:

Do any atoms of any fragment clash with any atoms of any other fragment, ignoring any atoms of said fragments that are bonded (bonded atoms inter-penetrate), and ignoring any atoms of the original fragments that would not be present in the final molecule?

This question is a global question over the whole molecule. This analysis contrasts with typical questions asked of pairs (i.e. bonding constraints) that only operate between two members of a pair. “Global” means that the clashing test looks at the molecule in a way that the tree doesn't directly represent, specifically, the view of the molecule given by the tree shows connectivity between A and B, and B and C, but says nothing about any relationship between A and C. For clashing, all combinations must be checked.

In addition to that, the algorithm checks for clashes between atoms that are not involved in an inter-fragment bond, and creates a “view” of the fragments that illuminates which atoms are members of bonds and which has no atoms that aren't in the final molecule. Going back to the “stack of bonds” described in the previous section, atoms in each fragment at the top-most position that they occur in the tree are viewed, as these tree positions can supply views of the fragments that exclude the atoms not in the final molecule.

Implementing Tree Traversal

The public interface to the various tree nodes implies in several cases an implicit tree traversal for a method call. Sometimes it is desirable to write code that explicitly traverses the tree, and there is an infrastructure for this.

For example, if an algorithm is needed for traversing the tree from top to bottom, identifying the top-most tree view of each fragment, and saving the bond atoms as it goes. Going back to example 3, at the position labelled 1 in the tree, full information about fragments B & C are known, and at position labelled 2 in the tree, full information about fragment A is known. The algorithm would traverse the tree from the top-down, identifying these positions for the fragments, and accumulating bond atoms from each bonding node in the tree.

A useful design pattern for operating on a composite data structure like these trees that provides the framework needed to do such a tree traversal in a type-safe way is the Visitor design pattern from Design Patterns, by Gamma, Heim, Johnson & Vlissides. This pattern is implemented for objects that perform aggregate operations on these trees such as traversal.

Each type of node in the tree has a method called Accept ( ) that looks like this:

class BondingComputation
{
public:

...

| | |
|---|---|
| virtual void | Accept (BondingComputationVisitor& v) { |

v.Visit (*this); }

...
}

Thus any node can “Accept” an object derived from BondingComputationVisitor, and invoke a Visit( ) method on that object passing the node to the visitor.

A visitor looks like this:

class BondingComputationVisitor
{
public:
...

| virtual void | Visit (ConcreteFragmentSource& x) | |
|---|---|---|
| { | | |
| // ... do something with distribution x ... | | |
| } | | |
| virtual void | Visit (FirstFragmentOfPair& x) | |
| { | | |
| // ... do something with distribution x ... | | |
| } | | |
| virtual void | Visit (SecondFragmentOfPair& x) | {et cetera} |
| virtual void | Visit (AllFragmentOfPairs& x) | {et cetera} |
| virtual void | Visit (SingleBondFilter& x) | {et cetera} |
| virtual void | Visit (ClashFilter& x) | {et cetera} |

// ... one more for each concrete type in the tree ...

};

How Do Trees Get Built?

In the present embodiment of the algorithm, molecules are built successively by attaching fragments to fragments to fragments. At the simplest, the algorithm joins two distributions of fragments together analogous to FIG. 11. To build more complex molecules, the algorithm can continue to attach fragments to an existing molecule to build ever more complex molecules. This process of building molecules with ever more fragments is either driven by the user selecting fragments to attach together via a 3D graphical user interface, similar to the existing WebLab DSViewer product, or via the previously described automatic build process. The process which the current algorithm performs to join each new fragment is as follows.

1. The algorithm enumerates all possible chemical bonds between the existing molecule and the new fragment, and retains those combinations that have 3D geometries that satisfy all atomic bond distance and angle criteria, as described in previous sections. At this step, any additional transformations such as the previously-described methyl/methane rotations are done, if necessary.

2. The algorithm, using Pascal's Triangle, enumerates all permutations of the proposed chemical bonds between the molecule and the new fragment retains any permutation that satisfies all atomic bond distance and angle criteria.

3. The algorithm explores whether any additional bonds may be made that would close one or more cycles, and if so retains any additional molecules with cyclic structures that meet all bond distance and angle criteria.

4. Finally, the entire proposed set of molecules is evaluated for inter-fragment van der Waals clashes, and any molecules with such clashes are discarded.

Embodiments of this algorithm may be performed iteratively over an exhaustive list of fragments from a set of fragment simulations to find molecules in the whole set of simulations, or a more narrow set defined by a chemist.

As an important performance optimization, the current embodiment of the algorithm will re-factor the molecule tree to attach the new fragments in an optimal way to the existing molecule.

Performance Optimization—Tree Refactoring

Given two fragment distributions, say we want to find all of the trees that represent each way we join the fragments together, To do this, we use the BondFinder class:

class BondFinder
{
public:

| ... | |
|---|---|
| Candidates_t | FindAllPairs( |

shared_ptr<FragmentSource> f1,
shared_ptr<FragmentSource> f2,
bool checkDistance = true) const;

void ResolveMultipleBonds(Candidates_t& pairs);
void ResolveCycles(Candidates_t& molecules);
void ResolveClashes(Candidates_t& molecules);
...

};

The process for using this class to find fragments that are joined together is as follows:

1. Use BondFinder::FindAllPairs to find all the ways to join the two distributions.

2. Use BondFinder::ResolveMultipleBonds to find all the permutations of the above bonds that are valid.

3. Use BondFinder::ResolveCycles to find all of the permutations of cycles that are valid.

4. Use BondFinder::ResolveClashes to cull any molecules that have clashes.

BondFinder::FindAllPairs iterates over a set of rules at each atom position to discover what bonds are valid between fragments, and any necessary fragment transformations (such as methyl rotation) that must be done to find the valid bonds.

This process is performed in the BondFinder::FindNearbyAttachment functions. These functions are the main functions used to join new fragments to an existing molecule. They take as input a molecule and a list of fragment names and attempt to join each fragment type to a fragment that already exists in the molecule. As an important performance optimization, BondFinder::FindNearbyAttachment uses RefactorBonds to attach the new fragments in an optimal way to the existing molecule.

| Collaboration diagram for RefactorBonds: | | |
|---|---|---|
| List of all members | | |
| Public Member Functions | | |
| shared_ptr< | operator( ) | (shared_ptr< |
| PairedFragmentSource> | | |

PairedFragmentsSource> top, const PairedFragmentsSource &at_pair,
bool at_pair_first)

| | |
|---|---|
| PairedFragmentsSource& | splice_position ( ) const |

| | |
|---|---|
| Shared_ptr< | refactored_top ( ) const |
| PairedFragmentsSource> | |

| | |
|---|---|
| bool | refactored_first ( ) const |
| (A) | Detailed Description |

This class represents an important optimization. Given a molecule with more than two fragments bonded together, there are multiple higher-order functions that would describe such a molecule. For example, say fragment A is bonded to fragment B to fragment C, we could first find all the valid combinations of A and B, then from those B's that were valid, find all of the combinations of B and C:
F(A, B, C)=F2(F1(A, B),C) (1)

This would have been done in the reverse order and get the same answer:
F(A, B, C)=F1(A, F2(B, C) (2)

However, suppose another fragment is bonded to C, i.e., have A-B-C-D. It would be more efficient to do this against (1) like so:
F(A, B, C, D)=F3(F2(F1 (A, B), C), D) (3)
because only those C fragments that already can simultaneously exist with A and B would be considered. If (2) was used instead, the function must be written this way:
F(A, B, C, D)=F1(A, F2(B, F3(C, D))) (4)

If only a single fragment is substituted at position D, then it doesn't matter which form of the function to choose, but if 150 fragments at position D must be substituted, then it is vastly more efficient, if there is only (2), to re-factor it into (1) than to try to operate on (2) directly.

The current embodiment of the algorithm performs the above tree rewriting optimization by first performing a recursive depth-first traversal of the tree to find the top-most position of the fragment to be joined. Once the traversal is done, as the recursive traversal functions return, and un-wind the recursion, the algorithm keeps track of what nodes in the tree are “above” the desired fragment in the tree. Using this information, a new tree is created that represents a re factored tree with the desired fragment at the top of the tree.

Software and Computer Implementation

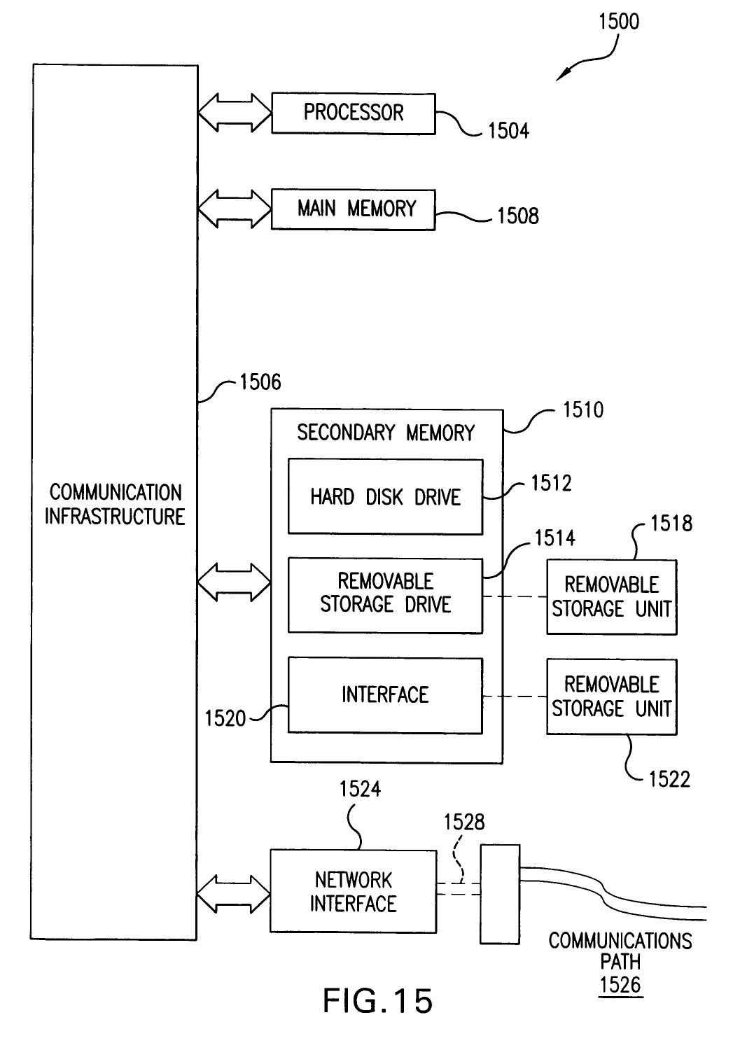

The present invention may be implemented using software and may be implemented in conjunction with a computing system or other processing system. An example of such a computer system 1500 is shown in FIG. 15. The computer system 1500 includes one or more processors, such as processor 1504. It is to be noted that the here-described fragment-based computation is particularly well suited for being carried out on a computer cluster, each cluster node computing the interaction of a given fragment type with the target protein. The processor 1504 is connected to a communication infrastructure 1506, such as a bus or network. Various software implementations are described in terms of this exemplary computer system. After reading this description, it will become apparent to a person skilled in the relevant art how to implement the invention using other computer systems and/or computer architectures.

Computer system 1500 also includes a main memory 1508, preferably random access memory (RAM), and may also include a secondary memory 1510. The secondary memory 1510 may include, for example, a hard disk drive 1512 and/or a removable storage drive 1514, representing a magnetic tape drive, an optical disk drive, etc. The removable storage drive 1514 reads from and/or writes to a removable storage unit 1518 in a well-known manner. Removable storage unit 1518 represents a magnetic tape, optical disk, or other storage medium that is read by and written to by removable storage drive 1514. As will be appreciated, the removable storage unit 1518 can include a computer usable storage medium having stored therein computer software and/or data.

In alternative implementations, secondary memory 1510 may include other means for allowing computer programs or other instructions to be loaded into computer system 1500. Such means may include, for example, a removable storage unit 1522 and an interface 1520. An example of such means may include a removable memory chip (such as an EPROM, or PROM) and associated socket, or other removable storage units 1522 and interfaces 1520 which allow software and data to be transferred from the removable storage unit 1522 to computer system 1500.

Computer system 1500 may also include one or more communications interfaces, such as network interface 1524. Network interface 1524 allows software and data to be transferred between computer system 1500 and external devices. Examples of network interface 1524 may include a modem, a network interface (such as an Ethernet card), a communications port, a PCMCIA slot and card, etc. Software and data transferred via network interface 1524 are in the form of signals 1528 which may be electronic, electromagnetic, optical or other signals capable of being received by network interface 1524. These signals 1528 are provided to network interface 1524 via a communications path (i.e., channel) 1526. This channel 1526 carries signals 1528 and may be implemented using wire or cable, fiber optics, an RF link and other communications channels.

In this document, the terms “computer program medium” and “computer usable medium” are used to generally refer to media such as removable storage units 1518 and 1522, a hard disk installed in hard disk drive 1512, and signals 1528. These computer program products are means for providing software to computer system 1500.

Computer programs (also called computer control logic) are stored in main memory 1508 and/or secondary memory 1510. Computer programs may also be received via communications interface 1524. Such computer programs, when executed, enable the computer system 1500 to implement the present invention as discussed herein. In particular, the computer programs, when executed, enable the processor 1504 to implement the present invention. Accordingly, such computer programs represent controllers of the computer system 1500. Where the invention is implemented using software, the software may be stored in a computer program product and loaded into computer system 1500 using removable storage drive 1514, hard drive 1512 or communications interface 1524.

While various embodiments of the present invention have been described above, it should be understood that they have been presented by way of example, and not limitation. It will be apparent to persons skilled in the relevant art that various changes in detail can be made therein without departing from the spirit and scope of the invention. Thus the present invention should not be limited by any of the above-described exemplary embodiments.

What is claimed is:

1. A computer based method of representing a macromolecule and a plurality of fragments in a computer, comprising:
(a) from a set of locations, orientations and free energy values for a plurality of molecular fragments, clumping in the computer the molecular fragments that are close to each other in three dimensional space and that have similar orientations;
(b) assigning in the computer one or more physical or chemical features to a representative fragment of said clump; and
(c) generating a computer readable representation of the macromolecule, wherein the plurality of molecular fragments are represented by the fragment having the assigned features.

2. The method of claim 1, wherein said at least one feature in (b) is determined by averaging the physical or chemical features of the fragments that are clumped together.

3. The method of claim 1, wherein said fragments are defined to be close to each other in three dimensional space when the center of mass of each fragment is within between about 0.1 and about 0.5 Å a preselected base fragment.

4. The method of claim 1, wherein said fragments are defined to have similar orientations when the fragments are between about 5 and about 25 degrees in any direction from a preselected base fragment.

5. The method of claim 1, wherein said assigning comprises assigning an energy to said representative fragment.

6. The method of claim 5, wherein said energy is the lowest energy observed between said plurality of molecular fragments and a macromolecule.

7. The method of claim 1, further comprising gathering said clumps into distributions, wherein a distribution is a set of clumps with the same or similar energy levels that are in proximity to one another.

8. The method of claim 7, further comprising excluding from said distribution fragment clumps that are outside a defined macromolecule binding site.

9. The method of claim 8, further comprising excluding from said distribution fragment clumps with a macromolecule binding energy over a predetermined threshold.

10. The method of claim 8, further comprising excluding from said distribution fragment clumps with a low solvent-accessible surface area.

11. The method of claim 8, further comprising determining when a first representative fragment from a first clump can bond to a second representative fragment from a second clump.

12. The method of claim 8, further comprising determining when all fragments within a distribution can be bonded to a second distribution.

13. The method of claim 12, wherein said determining comprises:
determining if a vector between hydrogen atoms in the first and second representative fragment is substantially linear and if heavy atoms bonded to said hydrogen atoms are within a preselected bonding distance, wherein said first and second fragments can bond when said vectors of said first and second fragments are substantially co-linear and within the predetermined bonding distance.

14. The method of claim 13, wherein said predetermined bonding distance is between about 1.00 Å and about 2.25 Å.

15. The method of claim 13, wherein linear is defined by the angle between the heavy atom of the first fragment, the heavy atom of the second fragment, and the hydrogen attached to the heavy atom of the second fragment.

16. The method of claim 15, wherein the vector is linear when the angle is between about 0° and about 15°.

17. The method of claim 12, wherein said determining comprises: determining if a first methyl group from the first fragment is in proximity to a second methyl group from the second fragment, wherein if a first methyl group from a first fragment is in proximity to a second methyl group from a second fragment, said fragments can form a bond with each other.

18. The method of claim 17, further comprising:
(a) removing the first methyl group from the first fragment;
(b) removing hydrogens from the second methyl group of the second fragment; and
(c) placing a bond between the carbon of the second methyl group to an atom from the first fragment that was bonded to the first methyl group.

19. A method of designing protein binding ligands, comprising:
(d) linking computer representations of molecular fragments to form a plurality of ligands;
(e) calculating in the computer at least one free energy of interaction between a protein and said plurality of ligands;
(f) sorting in the computer said plurality of ligands by the free energy of interaction between said protein and said ligand; and
(g) outputting a sorted list of said plurality of ligands.

20. The method of claim 19, further comprising, prior said linking, calculating at least one free energy of interaction between said protein and each molecular fragment, wherein each free energy of interaction is associated with a particular fragment position and location.

21. The method of claim 19, wherein said calculating in the computer at least one free energy of interaction between a protein and said plurality of ligands comprises summing the free energies of interaction between the protein and each molecular fragment that comprises said ligand.

22. The method of claim 20, wherein said calculation of said free energy of interaction between said protein and each molecular fragment comprises performing a Monte Carlo method that explores the protein/fragment conformational space.

23. The method of claim 22, wherein said Monte Carlo method comprises conventional Monte Carlo.

24. The method of claim 23, wherein said Monte Carlo method comprises linear Monte Carlo.

25. The method of claim 19, wherein said free energy of interaction is a Gibbs free energy.

26. The method of claim 19, wherein prior to linking said fragments to form said ligand, at least one putative ligand binding site on said protein is determined.

27. The method of claim 19, wherein the user selects a first fragment and a computer selects the remaining fragments used to form the ligand.

28. The method of claim 27, wherein the type of fragment selected by the computer is limited to those fragments that contain a particular functional group.
